(19) United States
(12) Patent Application Publication
(10) Pub. No.: US 2026/0038503 A1
(43) Pub. Date: Feb. 5, 2026

(54) VOICE PROCESSING SYSTEM, VOICE PROCESSING METHOD, AND RECORDING MEDIUM IN WHICH VOICE PROCESSING PROGRAM IS RECORDED

(71) Applicant: Sharp Kabushiki Kaisha, Sakai City (JP)

(72) Inventor: Noriko HATA, Sakai City (JP)

(21) Appl. No.: 19/266,289

(22) Filed: Jul. 11, 2025

(30) Foreign Application Priority Data
Aug. 2, 2024 (JP) 2024-127654

(51) Int. Cl. G10L 15/26; G10L 13/02

(52) U.S. Cl. CPC G10L 15/26; G10L 13/02

(57) ABSTRACT

A voice processing apparatus includes an acquisition processing unit that acquires a plurality of input voices input to microphones individually included in a plurality of audio devices, a synthesis processing unit that synthesizes the plurality of input voices acquired by the acquisition processing unit into a single synthesized voice, and an output processing unit that outputs the plurality of input voices and the synthesized voice to a conference server that converts the synthesized voice synthesized by the synthesis processing unit into text and individually converts each of the plurality of input voices into a piece of text among a plurality of pieces of text.

### INCORPORATION BY REFERENCE

This application is based upon and claims the benefit of priority from the corresponding Japanese Patent Application No. 2024-127654 filed on Aug. 2, 2024, the entire contents of which are incorporated herein by reference.

### BACKGROUND

The disclosure relates to a technique for converting speech voices into text (transcription) when a plurality of users individually use audio devices to have a conversation.

In the related art, a system is known in which a plurality of users can have a conversation by using audio devices each of which includes a microphone and a speaker. For example, there is known a system including a plurality of audio devices (personal speech devices) and a hub device that is installed in a conference space and that simultaneously connects the plurality of audio devices to a local network, in which the hub device constructs a group speech network that enables mutual simultaneous speeches among the connected audio devices.

For a conversation in which a plurality of users use respective audio devices, speech voices of the users may be converted into text (transcribed) and displayed. In this case, since individual speech can be acquired from each audio device and converted into text, text conversion (voice recognition) can be provided with high accuracy. However, in the known method, since the load of conversion processing to text increases and thus a delay of the conversion processing occurs, there is a problem that the real-time property of displaying the text during the conversation is impaired.

### SUMMARY

An object of the disclosure is to provide a voice processing system, a voice processing method, and a recording medium in which a voice processing program is recorded, the voice processing system, the voice processing method, and the recording medium being capable of converting voices of a conversation using a plurality of audio devices into text in real time and improving accuracy of the text conversion.

According to an aspect of the disclosure, there is provided a voice processing system including an acquisition processing unit, a synthesis processing unit, and an output processing unit. The acquisition processing unit acquires a plurality of input voices, each of the plurality of input voices being input to a microphone among a plurality of microphones, the plurality of microphones being individually included in a plurality of audio devices. The voice synthesis processing unit synthesizes the plurality of input voices acquired by the acquisition processing unit into a single first voice. The output processing unit outputs the plurality of input voices and the first voice to a conversion processing unit that converts the first voice synthesized by the synthesis processing unit into first text and individually converts each of the plurality of input voices into a piece of second text among a plurality of pieces of second text.

According to another aspect of the disclosure, there is provided a voice processing method that is executed by one or more processors, the voice processing method including acquiring a plurality of input voices, each of the plurality of input voices being input to a microphone among a plurality of microphones, the plurality of microphones being individually included in a plurality of audio devices, synthesizing the plurality of acquired input voices into a single first voice, and outputting the plurality of input voices and the first voice to a conversion processing unit that converts the first voice into first text and individually converts each of the plurality of input voices into a piece of second text among a plurality of pieces of second text.

According to another aspect of the disclosure, there is provided a recording medium in which a voice processing program is recorded, in which the voice processing program causes one or more processors to perform acquiring a plurality of input voices, each of the plurality of input voices being input to a microphone of a plurality of microphones, the plurality of microphones being individually included in a plurality of audio devices, synthesizing the plurality of acquired input voices into a single first voice and outputting the plurality of input voices and the first voice to a conversion processing unit that converts the first voice into first text and individually converts each of the plurality of input voices into a piece of second text among a plurality of pieces of second text.

According to the disclosure, a voice processing system, a voice processing method, and a recording medium in which a voice processing program is recorded can be provided that are capable of converting voices of a conversation using a plurality of audio devices into text in real time and improving accuracy of the text conversion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an application example of a voice processing system according to an embodiment of the disclosure.

FIG. 2 is a block diagram illustrating a configuration of the voice processing system according to the embodiment of the disclosure.

FIG. 3 is a diagram illustrating an example of information of instruments utilized in the voice processing system according to the embodiment of the disclosure.

FIG. 4 is a diagram illustrating an example of voice information utilized in the voice processing system according to the embodiment of the disclosure.

FIG. 5 is a diagram illustrating a specific example of voices input to audio devices according to the embodiment of the disclosure.

FIG. 6 is a diagram illustrating a specific example of processing of voices acquired from the audio devices according to the embodiment of the disclosure.

FIG. 7 is a diagram illustrating a specific example of processing of voices acquired from the audio devices according to the embodiment of the disclosure.

FIG. 8 is a flowchart for describing an example of a procedure of voice control processing performed in a voice processing apparatus according to the embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

A voice processing system according to the disclosure can be applied to, for example, a case where a plurality of users in the same space (for example, a conference room) have a conversation (conference) by using respective audio devices each of which includes a microphone and a speaker. Note that the voice processing system can also be applied to a case in which a plurality of spaces are connected and users in the spaces have a conversation (for example, a teleconference).

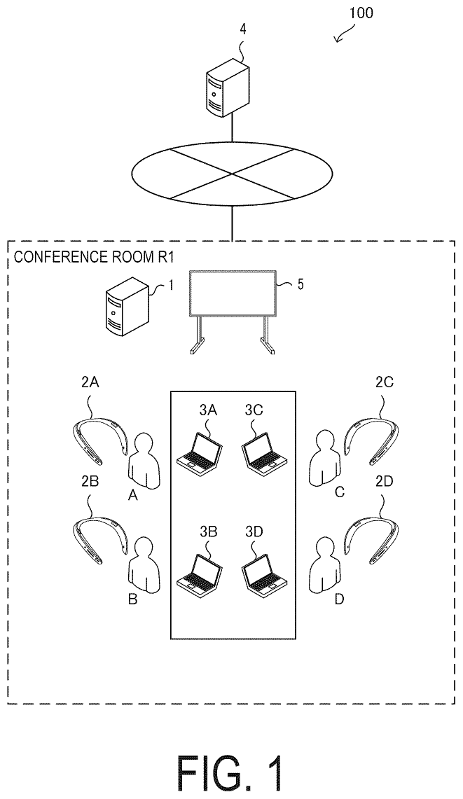

FIG. 1 illustrates an applied example of a voice processing system 100 according to the embodiment. As illustrated in FIG. 1, users A to D participate in a conference in a conference room R1. The users A to D have a conversation by respectively using neckband-type audio devices 2A to 2D each of which can be worn on the neck.

Each of the audio devices 2 is wirelessly connected (connected based on Bluetooth (trade name)) to the voice processing apparatus 1. A voice input to the microphone of each of the audio devices 2 is input to the voice processing apparatus 1 and is output (played) from the speaker of each of the audio devices 2.

As described above, the voice processing system 100 is a system that enables a plurality of users to have a conversation in the same space (the conference room R1 in FIG. 1) by individually using the audio devices 2. The voice processing system 100 may include a display device 5 that can be used in a conference. A conference application displays, on the display device 5, conference information such as camera images of the conference participants and conference materials, and conversion results (text information) acquired by converting voices into text by character conversion processing (transcription).

As illustrated in FIG. 1, the voice processing system 100 includes the voice processing apparatus 1, the audio devices 2, user terminals 3, and a conference server 4. The audio device 2 is a wireless connection-based sound instrument equipped with a microphone and a speaker. The voice processing system 100 is a system that includes a plurality of audio devices 2 and transmits and receives voice data of speech voices of users to and from the plurality of audio devices 2. The audio devices 2 may be sound instruments of the same type or of different types. For example, the plurality of audio devices 2 may include wireless connection-based sound instruments and wired connection-based sound instruments. Further, the plurality of audio devices 2 may include neckband-type sound instruments, headset-type sound instruments, and stationary sound instruments. Further, the audio device 2 may be built into the user terminal 3.

The voice processing apparatus 1 controls voices (input voices, output voices, and the like) to and from the audio devices 2, and performs processing of transmitting and receiving voices to and from the plurality of audio devices 2 when a conference is started in a conference room, for example. For example, the voice processing apparatus 1 controls the plurality of audio devices 2 arranged in the same space. In addition, the voice processing apparatus 1 accumulates voices acquired from the audio devices 2 as recording voices and performs processing (character conversion processing) of converting the acquired voices into text. Note that the voice processing apparatus 1 alone may constitute the voice processing system of the disclosure. The voice processing apparatus 1 may include a text conversion engine and perform the character conversion processing by itself. Alternatively, the voice processing apparatus 1 may output voice data to an external server without including the text conversion engine, the server may perform the character conversion processing, and thus, the voice processing apparatus 1 may receive the converted text data from the server.

Further, the voice processing system of the disclosure may include a function of providing various services such as a conference service, a caption (transcription) service by voice recognition, a translation service, and a minutes service. In the present embodiment, the voice processing system 100 includes the conference server 4 that provides the conference service. The conference server 4 provides a conference service of the conference application that is one type of general-purpose software. For example, the conference application is installed in the user terminal 3. Activating and logging in the user terminal 3 enable execution of a conference utilizing the conference application. In the present embodiment, the conference server 4 performs processing (character conversion processing, transcription) of converting the voice input to each audio device 2 into text and displaying the text on the user terminals 3, the display device 5, and the like. Note that when the voice processing apparatus 1 performs the character conversion processing, the conference server 4 does not need to include the character conversion function (text conversion engine).

The user terminals 3 are personal computers that the users participating in the conference have and each user can start the conference application on the user terminal 3 and view a conference screen.

### Voice Processing Apparatus 1

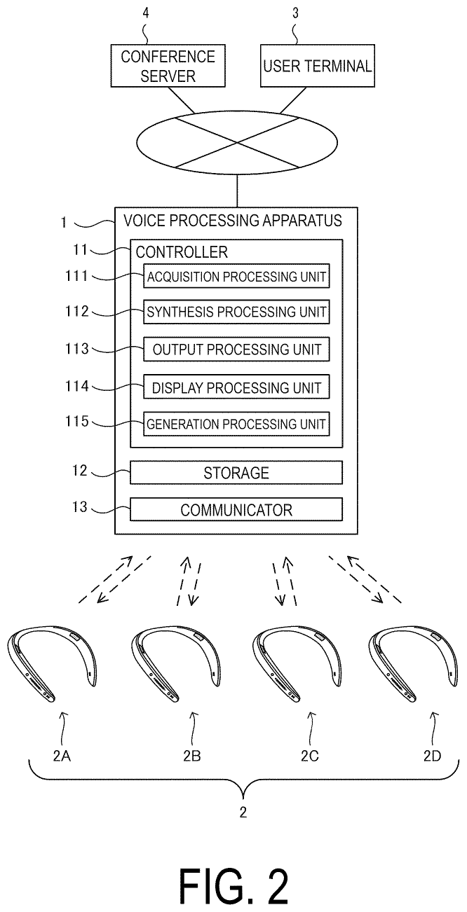

As illustrated in FIG. 2, the voice processing apparatus 1 is an instrument including a controller 11, a storage 12, and a communicator 13. For example, the voice processing apparatus 1 is connected to the plurality of audio devices 2, and includes a function of mixing or splitting voices input from the plurality of audio devices 2. Note that the voice processing apparatus 1 may have a character conversion function of converting an input voice into text.

The communicator 13 is used to connect the voice processing apparatus 1 to a communication network in a wired or wireless manner and to perform data communication with external instruments such as the audio devices 2, the user terminals 3, the conference server 4, the display device 5, and the like via the communication network in accordance with a predetermined communication protocol. For example, the communicator 13 performs pairing processing in accordance with the Bluetooth scheme to wirelessly connect to each audio device 2.

The storage 12 is a non-volatile storage such as a Hard Disk Drive (HDD), a Solid State Drive (SSD), or a flash memory that stores various types of information. The storage 12 stores data such as instrument information D1 related to the audio devices 2 and voice information D2 related to speech voices.

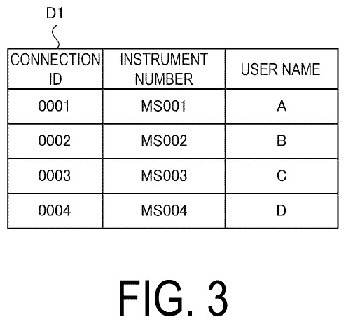

FIG. 3 illustrates an example of the instrument information D1. In the instrument information D1, information such as a connection ID, an instrument number, and a user name is registered. The connection ID is identification information (instrument information) utilized when the audio device 2 is connected, and is, for example, a Bluetooth address. The instrument number is identification information such as a unique number, and a name of the audio device 2. Instead of the connection ID and the instrument number, identification information such as an identifier assigned by the voice processing system 100 or a USB port number may be registered. The user name is a name of a user who uses the audio device 2. In this manner, in the instrument information D1, the audio device 2 and the identification information of the user are registered in association with each other. In the example illustrated in FIG. 3, an instrument number “MS001” indicates the audio device 2A to be used by the user A, an instrument number “MS002” indicates the audio device 2B to be used by the user B, an instrument number “MS003” indicates the audio device 2C to be used by the user C, and an instrument number “MS004” indicates the audio device 2D used by the user D.

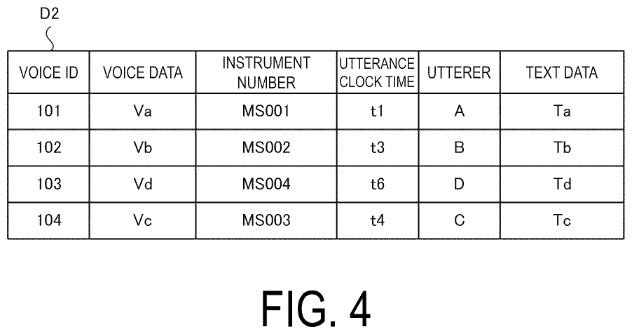

FIG. 4 illustrates an example of the voice information D2. In the voice information D2, information such as a voice ID, voice data, an instrument number, an utterance clock time, an utterer, and text data is registered. The voice ID is identification information of the voice corresponding to an utterance content of a user (utterer). The voice data is data of a voice (speech voice) acquired from the audio device 2. The instrument number is identification information of the audio device 2, and is stored in association with the instrument information D1 (see FIG. 3). Each piece of voice data is stored in association with the instrument number. The utterance clock time is a clock time at which the user has made an utterance, and examples of the utterance time include an utterance start time and an utterance end time. The utterer is the name of the user or the identification information thereof (user ID). The text data is character information obtained by converting a voice uttered by the user into text. In the present embodiment, the conference server 4 performs processing of converting a voice into text, and the converted text data is registered in the voice information D2. When the conference is started, the controller 11 registers each piece of information in the voice information D2 based on a speech voice of the user acquired from the audio device 2.

In the example illustrated in FIG. 4, a voice Va of a voice ID “101” indicates a voice acquired from the audio device 2A of the user A, and a text Ta indicates text data into which the voice Va is converted. Further, a voice Vb of a voice ID “102” indicates a voice acquired from the audio device 2B of the user B, and a text Tb indicates text data into which the voice Vb is converted.

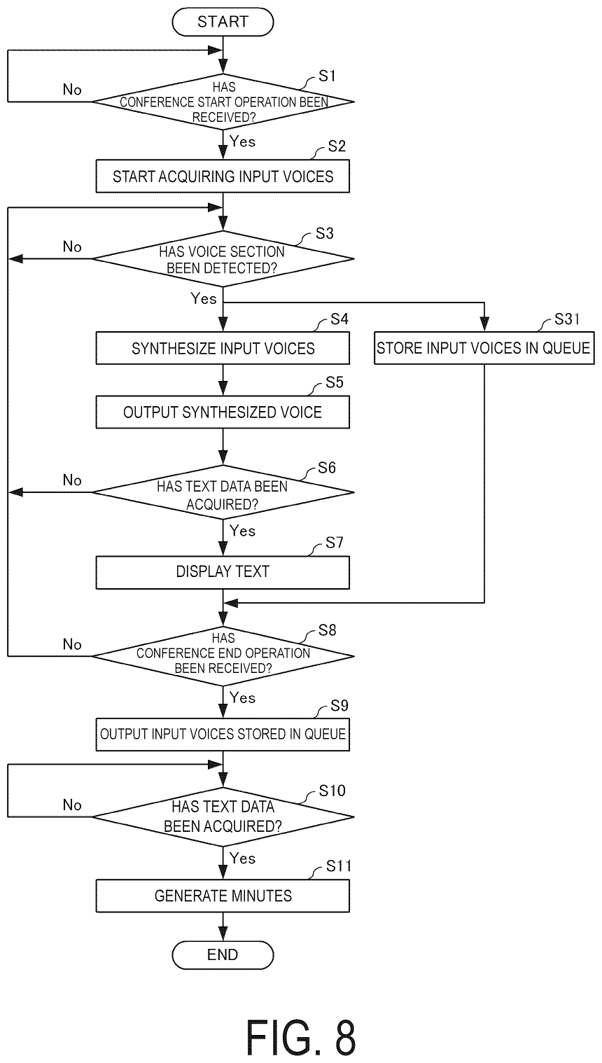

Further, the storage 12 stores a control program such as a voice control program (an example of the voice processing program of the disclosure) for causing the controller 11 to perform voice control processing, which will be described below (see FIG. 8). For example, the voice control program may be recorded non-transitorily on a computer-readable recording medium such as a CD or a DVD, read by a reading device (not illustrated) such as a CD drive or a DVD drive included in the voice processing apparatus 1, and stored in the storage 12.

The controller 11 includes a control element such as a Central Processing Unit (CPU), a Read Only Memory (ROM), and a Random Access Memory (RAM). The CPU is a processor that performs various types of arithmetic processing. The ROM is a non-volatile storage that stores, in advance, control programs such as a Basic Input/Output System (BIOS) and an Operating System (OS) for causing the CPU to perform various types of arithmetic processing. The RAM is a volatile or non-volatile storage that stores various types of information and is used as a temporary storage memory (work area) for the various types of processing performed by the CPU. Then, the controller 11 controls the voice processing apparatus 1 by causing the CPU to execute various types of the control programs stored in advance in the ROM or the storage 12.

Specifically, as illustrated in FIG. 2, the controller 11 includes various processing units such as an acquisition processing unit 111, a synthesis processing unit 112, an output processing unit 113, a display processing unit 114, and a generation processing unit 115. Note that the controller 11 functions as the various types of processing units by executing various types of processing in accordance with the control program using the CPU. Some or all of the processing units may be constituted by an electronic circuit. Note that the control programs may be programs for causing a plurality of processors to function as the processing units described above.

The acquisition processing unit 111 acquires a voice uttered by the user. Specifically, the acquisition processing unit 111 acquires a plurality of input voices, each of the plurality of input voices being input to a microphone among a plurality of microphones, the plurality of microphones being individually included in the plurality of audio devices 2. For example, when the conference is started and a user makes an utterance, the acquisition processing unit 111 acquires the speech voice (input voice) input to the microphone of the audio device 2 of the user. Further, the acquisition processing unit 111 acquires time information corresponding to the utterance clock time of the speech voice of the user. For example, the acquisition processing unit 111 acquires a clock time at which the speech voice of the user is input to the microphone of the audio device 2 or a clock time at which the speech voice is acquired.

When acquiring the voice from the audio device 2, the acquisition processing unit 111 stores the voice data in the voice information D2 (see FIG. 4) in association with the identification information of the audio device 2 (the instrument number, the connection ID, the instrument name, and the like). In the example illustrated in FIG. 1, the acquisition processing unit 111 acquires, from the audio devices 2A to 2D, speech voices of the users A to D in the conference room R1, and stores, in the voice information D2, the input voices Va to Vd in association with the instrument numbers.

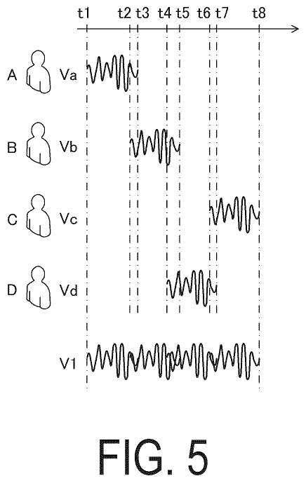

FIG. 5 illustrates an example of the voices (input voices) acquired from the respective audio devices 2. The input voice Va indicates a voice uttered by the user A during a time period from a clock time t1 to a clock time t3, the input voice Vb indicates a voice uttered by the user B during a time period from a clock time t2 to a clock time t5, the input voice Vc indicates a voice uttered by the user C during a time period from a clock time t6 to a clock time t8, and the input voice Vd indicates a voice uttered by the user D during a time period from a clock time t4 to a clock time t7. Note that the input voice Va and the input voice Vb overlap with each other in a section from the clock time t2 to the clock time t3, the input voice Vb and the input voice Vd overlap with each other in a section from the clock time t4 to the clock time t5, and the input voice Vc and the input voice Vd overlap with each other in a section from the clock time t6 to the clock time t7.

The synthesis processing unit 112 synthesizes the plurality of input voices acquired by the acquisition processing unit 111 into a single voice (synthesized voice V1). The synthesized voice V1 is an example of the first voice of the disclosure. To be specific, the synthesis processing unit 112 detects a portion (voice section) in which voices are present from voice streams acquired from the audio devices 2 and synthesizes a plurality of voices in the detected voice section into a single synthesized voice V1. For example, the synthesis processing unit 112 detects a voice section by using a silent state for a predetermined time period as a trigger and extracts a plurality of voices. In the example illustrated in FIG. 5, the synthesis processing unit 112 synthesizes the input voices Va to Vd of the users A to D corresponding to a voice section (from the clock time t1 to the clock time t8) to generate the synthesized voice V1.

The output processing unit 113 outputs the plurality of input voices acquired by the acquisition processing unit 111 and the synthesized voice synthesized by the synthesis processing unit 112 to a conversion processing unit (character conversion device) having a character conversion function (function of converting a voice into text). For example, the output processing unit 113 outputs the synthesized voice V1 obtained by synthesizing the input voices Va to Vd acquired from the audio devices 2A to 2D of the users A to D, respectively, to the conference server 4 that performs the character conversion processing (transcription).

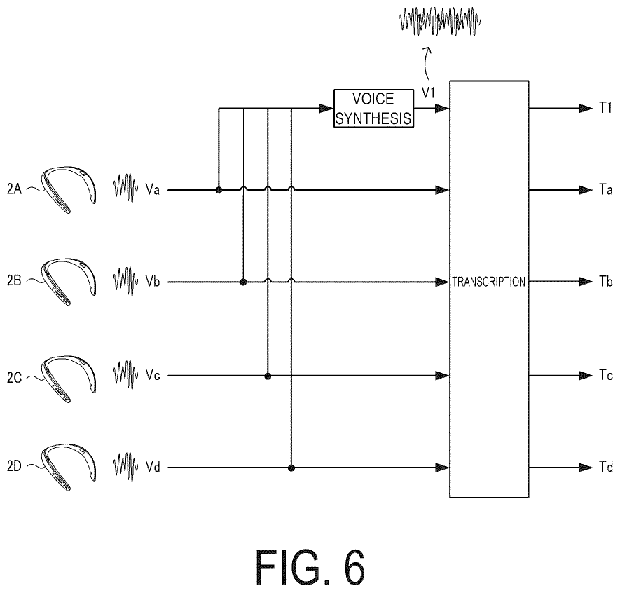

FIG. 6 schematically illustrates a configuration in which the voices are output from the voice processing apparatus 1 to the conference server 4. The conference server 4 performs text conversion processing based on the synthesized voice V1 to convert the synthesized voice V1 into text T1. The conference server 4 outputs the text data (text T1), which is the text conversion result, to the voice processing apparatus 1. When the controller 11 of the voice processing apparatus 1 acquires the data of the text T1 from the conference server 4, the controller 11 stores, in the storage 12, the data of the text T1 in association with the synthesized voice V1.

Further, the output processing unit 113 outputs, to the conference server 4, the input voices Va to Vd acquired from the audio devices 2A to 2D of the users A to D, respectively, in association with the respective pieces of the identification information (instrument numbers) of the audio devices 2A to 2D or the identification information (user names) of the users. That is, the output processing unit 113 individually outputs the input voices Va to Vd to the conference server 4. The conference server 4 performs the character conversion processing based on each of the input voices Va to Vd to convert the input voices Va to Vd into text. For example, the conference server 4 converts the input voice Va into the text Ta, converts the input voice Vb into the text Tb, converts the input voice Vc into the text Tc, and converts the input voice Vd into the text Td. Note that since the conference server 4 performs the character conversion processing on the individual voices, the character conversion accuracy can be improved as compared with a case where the character conversion processing is performed on the synthesized voice. The conference server 4 outputs the text data (the text Ta to the text Td), which is the character conversion result, to the voice processing apparatus 1. When the controller 11 acquires the text Ta to the text Td from the conference server 4, the controller 11 stores the text Ta to the text Td, in association with the respective input voices Va to Vd, in the storage 12 (the voice information D2 (see FIG. 4)).

In this manner, the output processing unit 113 individually outputs the plurality of input voices acquired by the acquisition processing unit 111 and the synthesized voice synthesized by the synthesis processing unit 112 to the conversion processing unit. The conference server 4 is an example of the conversion processing unit of the disclosure.

The display processing unit 114 causes the user terminal 3 or the display device 5 to display the text generated by the conversion processing unit (conference server 4). For example, the display processing unit 114 causes, on conference screens (not illustrated) of the user terminals 3A to 3D, the text T1 (see FIG. 4) obtained by converting the synthesized voice V1 from the conference server 4 into text to be displayed during the conference. Accordingly, the display processing unit 114 can cause the contents of the users' utterances to be displayed in text in real time during the conference.

The generation processing unit 115 generates minutes (a summary) of the conference based on the text generated by the conversion processing unit (conference server 4). For example, after the conference is finished, the generation processing unit 115 generates the minutes of the conference, based on the text Ta to the text Td (see FIG. 4) obtained by converting the input voices Va to Vd, respectively, into text from the conference server 4. According to the above configuration, since the minutes are generated by using the pieces of text obtained by converting the individual voices acquired from the respective audio devices 2, the minutes can be generated by using the highly accurate character conversion result.

Here, the output processing unit 113 may output the plurality of input voices Va to Vd to the conference server 4 after the processing of converting the synthesized voice V1 into the text T1 is ended. To be specific, the output processing unit 113 outputs the synthesized voice V1 to the conference server 4 during a predetermined time period (conference time period) in which the acquisition processing unit 111 is acquiring the plurality of input voices, and outputs the plurality of input voices to the conference server 4 after the predetermined time period elapses.

In this manner, the controller 11 causes the text into which the synthesized voice V1 is converted by the conference server 4 to be displayed during the users' utterances, and generates the minutes of the users' conversation based on a plurality of pieces of text into which the plurality of input voices Va to Vd are converted by the conference server 4. Accordingly, for example, the synthesized voice V1 is quickly converted into text and displayed in real time during the conference, and the individual input voices Va to Vd are converted into text with high accuracy after the conference is finished, thereby generating the minutes.

Note that the conference server 4 has a known character conversion function, and converts voices acquired from the voice processing apparatus 1 into text. In addition, when a remote conference is held, the conference server 4 transmits voices acquired from the voice processing apparatus 1 in the conference room R1 to a voice processing apparatus disposed in another space (at a remote place), and outputs the voices from the voice processing apparatus to a user who participates in the conference at a remote place. The conference server 4 may be a cloud server or a computer (personal computer) installed in the conference room R1. Further, in another embodiment, the voice processing apparatus 1 may have the character conversion function.

### OTHER EMBODIMENTS

In the above-described embodiment, the output processing unit 113 individually outputs each of the plurality of input voices Va to Vd to the conference server 4, but as another embodiment, the output processing unit 113 may store the plurality of input voices Va to Vd in a queue (storage area). The queue is a storage area set in the storage 12, and one queue may be set in the storage 12, or a plurality of queues may be set corresponding to the audio devices 2.

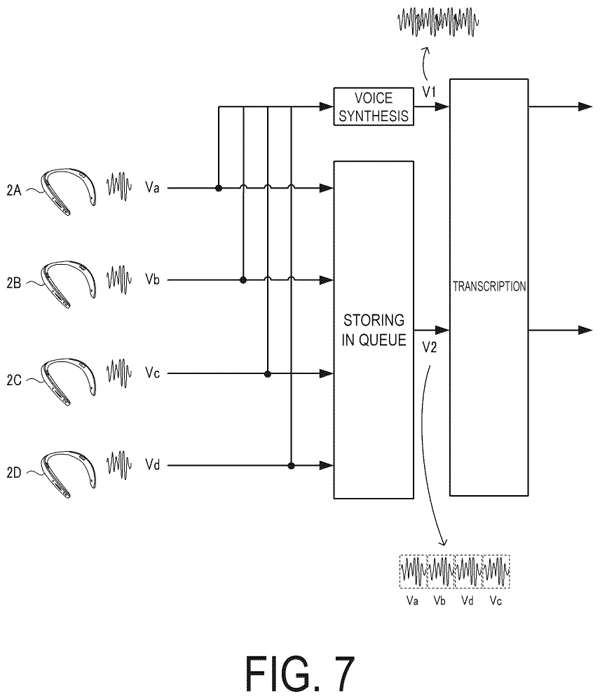

For example, as illustrated in FIG. 7, when acquiring the input voices Va to Vd from the audio devices 2A to 2D, respectively, the acquisition processing unit 111 individually stores the input voices Va to Vd in a queue. Further, the output processing unit 113 detects, for each audio device 2, a portion (voice section) in which a voice is present from a voice stream acquired from the audio device 2, and stores the input voice of only the detected audio section in the queue. For example, the output processing unit 113 detects a voice section from a voice stream acquired from the audio device 2A, stores the input voice Va of only the detected voice section in a queue, detects a voice section from a voice stream acquired from the audio device 2B, and stores the input voice Vb of only the detected voice section in the queue.

Further, the acquisition processing unit 111 arranges the input voices Va to Vd in an order of acquisition clock times and stores the input voices Va to Vd in the queue such that the input voices Va to Vd do not overlap each other. For example, the acquisition processing unit 111 stores, in a queue, the input voice Va obtained from the audio device 2A from the clock time t1 to the clock time t3 (see FIG. 5), stores, in the queue, the input voice Vb obtained from the audio device 2B from the clock time t2 to the clock time t5, stores, in the queue, the input voice Vd obtained from the audio device 2D from the clock time t4 to the clock time t7, and stores, in the queue, the input voice Vc obtained from the audio device 2C from the clock time t6 to the clock time t8. Further, the acquisition processing unit 111 stores each of the plurality of input voices in the queue in association with the identification information (instrument number) of the audio device 2 or the identification information (user name) of the user.

Further, the output processing unit 113 outputs the voices stored in the queue to the conference server 4. Specifically, the output processing unit 113 outputs the plurality of input voices to the conference server 4 such that the plurality of input voices do not overlap each other. For example, the output processing unit 113 outputs the input voices Va to Vd to the conference server 4 such that the input voices Va to Vd do not overlap with each other. For example, as illustrated in FIG. 5, the input voice Va and the input voice Vb overlap with each other in the section from the clock time t2 to the clock time t3, the input voice Vb and the input voice Vd overlap with each other in the section from the clock time t4 to the clock time t5, and the input voice Vc and the input voice Vd overlap with each other in the section from the clock time t6 to the clock time t7. Because of this, when the respective input voices are synthesized according to the input clock times, the voices are overlapped in the respective sections as illustrated in the synthesized voice V1. In contrast, the output processing unit 113 outputs the input voices Va to Vd to the conference server 4 with the time intervals of the input voices Va to Vd shifted from each other such that the voices do not overlap with each other in each of the sections described above. Further, the output processing unit 113 outputs, as a single voice (a voice stream V2), the input voices Va to Vd to the conference server 4 (see FIG. 7).

The conference server 4 performs the character conversion processing based on the single voice stream V2 output from the voice processing apparatus 1. This allows, for example, the conference server 4 to collectively convert the input voices Va to Vd into characters, further improving the accuracy of character conversion. For example, the conference server 4 can perform character conversion of each input voice in consideration of the contexts before and after the input voice with reference to other input voices, and thus can accurately perform the character conversion of each input voice according to the contexts.

As described above, according to the configuration illustrated in FIG. 7, it is possible to implement character conversion with high accuracy while reducing the number of times of character conversion (transcription). Specifically, using the input voices before synthesis allows the voices to be clearly delimited, and thus the voice recognition accuracy can be improved. Further, since the audio device 2 from which the voice is input is clarified, the utterer corresponding to the voice can be accurately identified. Further, since the number of voice streams to the conference server 4 is one (the voice stream V2), the processing load can be reduced. Furthermore, since the contexts (flow of conversation) before and after the voice can be taken into consideration, the accuracy of character conversion can be improved.

In the above configuration, the acquisition processing unit 111 may perform predetermined voice processing such as gain adjustment and noise removal on the input voice acquired from each audio device 2, detect the voice section described above after the voice processing, and store the input voice of the voice section in the queue. This improves the accuracy of detecting the voice section, thereby preventing a voice from being unnecessarily input to the queue and reducing the number of times of character conversion processing.

In addition, in the above configuration, when the input voices stored in the queue include a plurality of the same input voices of the same user, the output processing unit 113 may perform processing of deleting the duplicate input voice. For example, a voice uttered by the user A may be simultaneously input to both the microphone of the audio device 2A of the user A and the microphone of the audio device 2B of the user B. In this case, the input voices of the user A input from the audio device 2A and the audio device 2B may be stored in the queue. In this case, the input voice of the user A input from the audio device 2B may include reverberation and noise, causing a problem that the accuracy of the character conversion is lowered when the input voice is used. Thus, the output processing unit 113 performs processing of deleting the input voice of the user A acquired from the audio device 2B. This makes it possible to further improve the accuracy of the character conversion. In addition, when the silent state continues for a first predetermined time period or longer, a part in the silent time period may be deleted to shorten silent data up to a second predetermined time period, or voice data in the silent time period may be deleted and replaced with silent data for the second predetermined time period prepared in advance. Here, the second predetermined time period is shorter than the first predetermined time period. This makes it possible to reduce the load on the CPU for the character conversion processing and to shorten the character conversion processing time.

### Voice Control Processing

FIG. 8 illustrates an example of a procedure of voice control processing performed by the controller 11 of the voice processing apparatus 1.

Note that the disclosure can be regarded as a voice control method (the voice processing method of the disclosure) that executes a single step or a plurality of steps included in the voice control processing. In addition, the single step or the plurality of steps included in the voice control processing described herein may be omitted as appropriate. Further, the steps of the voice control processing may be executed in a different order to the extent that similar effects are obtained. Furthermore, here, a case where the controller 11 executes each step in the voice control processing will be described as an example, but in another embodiment, one processor or a plurality of processors may execute each step in the voice control processing in a distributed manner.

### Step S1

In step S1, the controller 11 determines whether an operation of starting a conference has been received. For example, the user A who is an organizer of the conference starts the conference application on the user terminal 3A and performs a conference start operation on a settings screen. In a case where the conference start operation has been received (S1: Yes), the controller 11 shifts the processing to step S2. The controller 11 waits until the conference start operation is received (S1: No).

### Step S2

In step S2, the controller 11 starts processing of acquiring, from the audio device 2, a voice uttered by a user. For example, when the conference is started and a voice uttered by the user A is input to the microphone of the audio device 2A, the controller 11 acquires the voice (input voice Va) from the audio device 2A. Further, when a voice uttered by the user B is input to the microphone of the audio device 2B, the controller 11 acquires the voice (input voice Vb) from the audio device 2B, when a voice uttered by the user C is input to the microphone of the audio device 2C, the controller 11 acquires the voice (input voice Vc) from the audio device 2C, and when a voice uttered by the user D is input to the microphone of the audio device 2D, the controller 11 acquires the voice (input voice Vd) from the audio device 2D. The controller 11 registers the acquired information about the input voice in the voice information D2 (see FIG. 4).

### Step S3

In step S3, the controller 11 determines whether a voice section has been detected. For example, the controller 11 detects a portion (voice section) in which voices are present from voice streams acquired from the respective audio devices 2. For example, in the example illustrated in FIG. 5, the controller 11 detects a voice section from the clock time t1 to the clock time t8 in which the input voices Va to Vd are present in the voice streams acquired from the audio devices 2A to 2D, respectively. When the controller 11 successfully detects the voice section of the voice streams acquired from the audio devices 2A to 2D, the controller 11 shifts the processing to step S4.

Further, the controller 11 detects a portion (voice section) in which the voice is present from the acquired voice stream for each audio device 2. For example, in the example illustrated in FIG. 5, the controller 11 detects a voice section from the clock time t1 to the clock time t3 in which the input voice Va is present in the voice stream acquired from the audio device 2A. When the controller 11 successfully detects the voice section from the acquired voice stream for each audio device 2, the controller 11 shifts the processing to step S31.

### Step S4

In step S4, the controller 11 synthesizes a plurality of input voices corresponding to the voice section. In the example illustrated in FIG. 5, the controller 11 synthesizes the input voices Va to Vd extracted in the voice section from the clock time t1 to the clock time t8 to generate a single synthesized voice V1.

### Step S5

In step S5, the controller 11 outputs the synthesized voice V1 to the conference server 4 that performs the character conversion processing. The conference server 4 performs processing of recognizing the synthesized voice V1 and converting the synthesized voice V1 into text data (text T1).

### Step S6

In step S6, the controller 11 determines whether the text data (character conversion result) has been acquired from the conference server 4. In a case where the text data has been acquired from the conference server 4 (S6: Yes), the controller 11 shifts the processing to step S7. On the other hand, in a case where the text data has not been acquired from the conference server 4 (S6: No), the controller 11 shifts the processing to step S3. For example, in a case where a voice section such as sneezing has been detected, the character conversion processing is not performed correctly, and thus text data does not exist in some cases. In such a case, the controller 11 does not acquire the text data (S6: No), and returns to step S3 to perform the above-described processing again.

### Step S7

In step S7, the controller 11 outputs the text data and causes an external terminal to display the text (characters, images, and the like). For example, the controller 11 causes the user terminals 3A to 3D to display the text T1 obtained by converting the synthesized voice V1 into characters on the conference screens thereof. In addition, the controller 11 also causes the display device 5 to display the text T1 on the conference screen thereof. After step S7, the controller 11 shifts the processing to step S8.

### Step S31

In step S31, the controller 11 stores the input voices corresponding to the voice sections in the queue. In the example illustrated in FIG. 5, the controller 11 stores the input voice Va extracted in the voice section from the clock time t1 to the clock time t3 in the queue in association with the identification information (instrument number) of the audio device 2A or the identification information (user name) of the user A. In addition, the controller 11 stores the input voice Vb extracted in the voice section from the clock time t2 to the clock time t5 in the queue in association with the identification information of the audio device 2B or the identification information of the user B, stores the input voice Vd extracted in the voice section from the clock time t4 to the clock time t7 in the queue in association with the identification information of the audio device 2D or the identification information of the user D, and stores the input voice Vc extracted in the voice section from the clock time t6 to the clock time t8 in the queue in association with the identification information of the audio device 2C or the identification information of the user C.

The controller 11 also stores the input voices Va to Vd in the queue with the input voices Va to Vd arranged in an acquisition clock time order while shifting the input voices Va to Vd in time such that the input voices Va to Vd do not overlap with each other. After step S31, the controller 11 shifts the processing to step S8.

### Step S8

In step S8, the controller 11 determines whether an operation of ending the conference has been received. For example, the user A ends the conference application in a case of ending the conference. Upon receiving the end operation of the conference application (S8: Yes), the controller 11 shifts the processing to step S9. On the other hand, in a case of not having received the end operation of the conference (S8: No), the controller 11 makes the processing return to step S3.

On returning to step S3, the controller 11 detects the next voice section, and performs the synthesis processing (S4) of the input voice and the storage processing (S31) in the queue. The controller 11 repeatedly performs the above-described processing until the conference ends. That is, the controller 11 continues the processing of displaying the text T1 of the synthesized voice V1 and storing each input voice in the queue until the conference ends.

### Step S9

In step S9, the controller 11 outputs the input voice stored in the queue to the conference server 4. Specifically, the controller 11 outputs the plurality of input voices to the conference server 4 such that the plurality of input voices do not overlap with each other. For example, the controller 11 outputs the input voices Va to Vd to the conference server 4 while shifting the input voices Va to Vd in time such that the voice sections of the input voices do not overlap with each other. Further, the controller 11 outputs the input voices Va to Vd as a single voice (the voice stream V2) to the conference server 4 (see FIG. 7).

The conference server 4 performs the character conversion processing based on the single voice stream V2 output from the voice processing apparatus 1. Further, the conference server 4 generates text in association with the identification information of the audio device 2 or the identification information of the user. For example, the conference server 4 converts the input voice Va into the text Ta and associates the text Ta with the identification information of the user A, converts the input voice Vb into the text Tb and associates the text Tb with the identification information of the user B, converts the input voice Vc into the text Tc and associates the text Tc with the identification information of the user C, and converts the input voice Vd into the text Td and associates the text Td with the identification information of the user D.

### Step S10

In step S10, the controller 11 determines whether text data has been acquired from the conference server 4. In a case where the controller 11 has acquired the text data (S10: Yes), the controller 11 shifts the processing to step S11. The controller 11 waits until the text data is acquired from the conference server 4 (S10: No). For example, the controller 11 acquires the data of the text T1 to the text T4 from the conference server 4.

### Step S11

In step S11, the controller 11 generates minutes, based on the text data acquired from the conference server 4. For example, the controller 11 generates the minutes, based on the text T1 to the text T4. Further, the controller 11 generates the minutes by adding the identification information (user name) of the user to each text. After the minutes are generated, the controller 11 ends the voice control processing.

The controller 11 performs the voice control processing as described above every time a conference is started, and generates minutes, based on text information of speech voices when the conference is ended while causing the speech voices to be displayed in text in real time during the conference. Note that as another embodiment, the controller 11 may generate the minutes in parallel while causing the speech voices to be displayed in text during the conference.

As described above, the voice processing system 100 according to the disclosure acquires a plurality of input voices each of which is input to a microphone among the plurality of microphones individually included in the plurality of audio devices 2 and synthesizes the plurality of acquired input voices into a single synthesized voice V1 (first voice). Further, the voice processing system 100 outputs the plurality of input voices and the synthesized voice V1 to a character conversion device (for example, the conference server 4).

This makes it possible to convert the synthesized voice V1 into text and display the text in real time. Further, each of the input voices input to the audio devices 2 can be individually converted into text, thereby improving the accuracy of text conversion (accuracy of voice recognition) of each input voice. Thus, it is possible to convert the voices of the conversation using the plurality of audio devices 2 into text in real time and improve the accuracy of text conversion.

Note that in the voice recognition processing, a voice in a first language (for example, Japanese) may be converted into text in the first language, or a voice in the first language (for example, Japanese) may be converted into text in a second language (for example, English).

As another embodiment of the present disclosure, the controller 11 may switch the processing of individually performing voice recognition (transcription) on the input voices between the method illustrated in FIG. 6 and the method illustrated in FIG. 7. The method illustrated in FIG. 6 is the method of individually outputting each of the input voices Va to Vd input from the audio devices 2 to the conference server 4 and causing the conference server 4 to perform the voice recognition processing. In contrast, the method illustrated in FIG. 7 is the method of storing the respective input voices input from the audio devices 2 in a queue, outputting the input voices from the queue as a single voice stream V2 to the conference server 4, and causing the conference server 4 to perform the voice recognition processing.

In particular, the output processing unit 113 switches between a first output mode in which each of the plurality of input voices Va to Vd is individually output to the conference server 4 and a second output mode in which the voice stream V2 is output to the conference server 4, based on the number of input voices stored in the queue.

For example, the output processing unit 113 sets the output mode to the first output mode when the number of input voices stored in the queue is equal to or larger than a predetermined number, and sets the output mode to the second output mode when the number of input voices stored in the queue is less than the predetermined number.

As another embodiment, the output processing unit 113 may set the output mode to the first output mode in a scene (such as a presentation scene) in which one user mainly utters and the other users do not utter, and may set the output mode to the second output mode in a scene in which a plurality of users ask and answer questions.

Note that the controller 11 of the voice processing apparatus 1 controls the entire voice processing apparatus 1. The controller 11 enables various functions by loading and executing various programs stored in the storage 12 (for example, a storage component or ROM). The controller 11 may be implemented by one or multiple control devices/arithmetic devices (such as a Central Processing Unit (CPU), a System on a Chip (SoC)). In addition, the controller 11 may include one or multiple control circuits (electronic circuits).

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

A voice processing system including:
an acquisition processing circuit that acquires a plurality of input voices, each of the plurality of input voices being input to a microphone among a plurality of microphones, the plurality of microphones being individually included in a plurality of audio devices; a synthesis processing circuit that synthesizes the plurality of input voices acquired by the acquisition processing circuit into a single first voice; and
an output processing circuit that outputs the plurality of input voices and the first voice to a conversion processing circuit that converts the first voice synthesized by the synthesis processing circuit into first text and individually converts each of the plurality of input voices into a piece of second text among a plurality of pieces of second text.

### Supplementary Note 2

The voice processing system according to Supplementary Note 1,
in which after processing of converting the first voice into the first text is completed, the output processing circuit outputs the plurality of input voices to the conversion processing circuit.

### Supplementary Note 3

The voice processing system according to Supplementary Note 1 or 2,
in which the output processing circuit outputs the first voice to the conversion processing circuit in a predetermined time period while the acquisition processing circuit is acquiring the plurality of input voices, and outputs the plurality of input voices to the conversion processing circuit after the predetermined time period elapses.

### Supplementary Note 4

The voice processing system according to any one of Supplementary Notes 1 to 3,
in which the output processing circuit outputs the plurality of input voices to the conversion processing circuit, and thus causes the plurality of input voices not to overlap with each other.

### Supplementary Note 5

The voice processing system according to any one of Supplementary Notes 1 to 4,
in which the acquisition processing circuit arranges the plurality of input voices in an order of acquisition clock times and thus causes the plurality of input voices not to overlap with each other, and stores the plurality of arranged input voices in a storage, and
the output processing circuit collectively outputs the plurality of input voices stored in the storage to the conversion processing circuit.

### Supplementary Note 6

The voice processing system according to Supplementary Note 5,
in which the acquisition processing circuit stores each of the plurality of input voices in the storage in association with identification information of a corresponding audio device among the plurality of audio devices.

### Supplementary Note 7

The voice processing system according to Supplementary Note 5 or 6,
in which the acquisition processing circuit performs predetermined voice processing on each of the plurality of input voices and stores the plurality of processed input voices in the storage.

### Supplementary Note 8

The voice processing system according to any one of Supplementary Notes 5 to 7,
in which the output processing circuit switches between a first output mode in which each of the plurality of input voices is individually output to the conversion processing circuit and a second output mode in which the plurality of input voices stored in the storage are collectively output to the conversion processing circuit, based on the number of the plurality of input voices stored in the storage.

### Supplementary Note 9

The voice processing system according to any one of Supplementary Notes 1 to 8,
in which the first text obtained by converting the first voice by the conversion processing circuit is displayed during user's utterances, and
minutes of a user's conversation are generated based on the plurality of pieces of second text into which the plurality of input voices are converted by the conversion processing circuit.

### Supplementary Note 10

A voice processing method that is executed by one or more processors, the voice processing method including:
acquiring a plurality of input voices, each of the plurality of input voices being input to a microphone among a plurality of microphones, the plurality of microphones being individually included in a plurality of audio devices;
synthesizing the plurality of acquired input voices into a single first voice; and
outputting the plurality of input voices and the first voice to a conversion processing circuit that converts the first voice into first text and individually converts each of the plurality of input voices into a piece of second text among a plurality of pieces of second text.

### Supplementary Note 11

A non-transitory computer-readable recording medium in which a voice processing program is recorded,
in which the voice processing program causes one or more processors to perform: acquiring a plurality of input voices, each of the plurality of input voices being input to a microphone among a plurality of microphones, the plurality of microphones being individually included in a plurality of audio devices;
synthesizing the plurality of acquired input voices into a single first voice; and
outputting the plurality of input voices and the first voice to a conversion processing circuit that converts the first voice into first text and individually converts each of the plurality of input voices into a piece of second text among a plurality of pieces of second text.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A voice processing system comprising:
one or more processors,
the one or more processors configured to:
acquire a plurality of input voices, each of the plurality of input voices being input to a microphone among a plurality of microphones, the plurality of microphones being individually included in a plurality of audio devices;
synthesize the plurality of acquired input voices into a single first voice; and
output the plurality of input voices and the first voice to a conversion processing unit that converts the synthesized first voice into first text and individually converts each of the plurality of input voices into a piece of second text among a plurality of pieces of second text.

2. The voice processing system according to claim 1,
wherein the one or more processors are configured to output the plurality of input voices to the conversion processing unit after processing of converting the first voice into the first text is completed.

3. The voice processing system according to claim 1,
wherein the one or more processors are configured to output the first voice to the conversion processing unit in a predetermined time period while acquiring the plurality of input voices, and output the plurality of input voices to the conversion processing unit after the predetermined time period elapses.

4. The voice processing system according to claim 1,
wherein the one or more processors are configured to output the plurality of input voices to the conversion processing unit, and thus cause the plurality of input voices not to overlap with each other.

5. The voice processing system according to claim 1,
wherein the one or more processors are configured to:
arrange the plurality of input voices in an order of acquisition clock times and thus cause the plurality of input voices not to overlap with each other, and store the plurality of arranged input voices in a storage; and
collectively output the plurality of input voices stored in the storage to the conversion processing unit.

6. The voice processing system according to claim 5,
wherein the one or more processors are configured to store each of the plurality of input voices in the storage in association with identification information of a corresponding audio device among the plurality of audio devices.

7. The voice processing system according to claim 5,
wherein the one or more processors are configured to switch between a first output mode in which each of the plurality of input voices is individually output to the conversion processing unit and a second output mode in which the plurality of input voices stored in the storage are collectively output to the conversion processing unit, based on the number of the plurality of input voices stored in the storage.

8. The voice processing system according to claim 1,
wherein the one or more processors are configured to:
display the first text obtained by converting the first voice by the conversion processing unit during user's utterances; and
generate minutes of a user's conversation, based on the plurality of pieces of second text into which the plurality of input voices are converted by the conversion processing unit.

9. A voice processing method that is executed by one or more processors, the voice processing method comprising:
acquiring a plurality of input voices, each of the plurality of input voices being input to a microphone among a plurality of microphones, the plurality of microphones being individually included in a plurality of audio devices;
synthesizing the plurality of acquired input voices into a single first voice; and
outputting the plurality of input voices and the first voice to a conversion processing unit that converts the first voice into first text and individually converts each of the plurality of input voices into a piece of second text among a plurality of pieces of second text.

10. A non-transitory computer-readable recording medium in which a voice processing program is recorded,
the voice processing program causing one or more processors to perform:
acquiring a plurality of input voices, each of the plurality of input voices being input to a microphone among a plurality of microphones, the plurality of microphones being individually included in a plurality of audio devices;
synthesizing the plurality of acquired input voices into a single first voice; and
outputting the plurality of input voices and the first voice to a conversion processing unit that converts the first voice into first text and individually converts each of the plurality of input voices into a piece of second text among a plurality of pieces of second text.
